(19) United States
(12) Patent Application Publication
(10) Pub. No.: US 2021/0260832 A1
(43) Pub. Date: Aug. 26, 2021

(54) WELDING HEAD AND WELDING DEVICE

(71) Applicant: LIQUI-BOX GERMANY GMBH, Schwetzingen (DE)

(72) Inventor: Michael Hering, Brühl (DE)

(21) Appl. No.: 17/260,363

(22) PCT Filed: Jul. 17, 2019
(86) PCT No.: PCT/EP2019/069186

§ 371 Date: Jan. 14, 2021

(30) Foreign Application Priority Data
Jul. 18, 2018 (DE) 10 2018 117 367.9

(51) Int. Cl. B29C 65/30; B29C 65/00; B29C 65/08; B29C 65/04

(52) U.S. Cl. CPC B29C 65/30; B29C 66/8122; B29C 66/81261; B29C 66/81431; B29L 2031/7128; B29C 65/08; B29C 65/04; B29C 66/73921; B29C 66/81433

(57) ABSTRACT

The present invention relates to a welding head (10) for fastening an element made of plastic material to one or more flexible webs (2, 3) made of plastic material, of which a flexible container (1) is composed. The head (10) includes a body made of electrically and/or thermally conductive material having a work surface (15) that is provided for being pressed, during the welding operation, against an element of the unit to be joined. The invention is characterized in that the work surface (15) includes a series of grooves or concave formations (16) that are essentially uniformly distributed on the surface of the work surface (15).

The present invention relates to the technical field of welding of elements made of plastic material for producing containers that are soft or flexible at least in part, such as in particular tubular bags for storing liquid, semiliquid, or powdered products. In one preferred but not exclusive application, the present invention relates to the technical field of welding a neck made of plastic material to one or more, generally two, flexible webs made of plastic material, of which a flexible container or a tubular bag is composed.

In the above-mentioned field it is known to join the various elements made of plastic material, of which a flexible container is composed, by thermal welding, or also high-frequency electromagnetic or ultrasonic welding.

In the case of the tubular bag made of flexible plastic material, it is known to insert a neck, made of plastic material, which on the one hand allows rapid filling of the tubular bag, and on the other hand allows mounting of a spigot for tapping the contents of the tubular bag. The neck made of plastic material generally has a cylindrical, tubular shaft which in its base area includes an annular collar (“flange”) which allows fastening by welding to a flexible web made of plastic material, and which is provided to form one of the walls of the tubular bag. The welding of the neck is usually carried out before the tubular bag is completely formed. To ensure this weld, a welding head is used which includes a body with a smooth work surface that is provided to come into contact with one of the two elements to be joined, and more generally, to come into contact with the flexible web made of plastic material. For the welding of the neck, the welding head has an essentially tubular shape with a ring-shaped work surface having essentially the same shape as the fastening collar of the neck. The device for carrying out the welding also includes a counterhead which is provided to cooperate with the welding head in order to press the joining zone between the welding head and the counterhead during the welding operation. During the welding operation, the welding zone is activated thermally or by electromagnetic high frequency or ultrasound in order to bring about melting of the surface of the collar at the point of contact with the flexible web, thus establishing a durable and at least liquid-tight connection. In certain cases, due to the applied pressure a portion of the molten plastic material flows to the outer side of the joining zone, and after cooling may form sharp ridges that may puncture the flexible web during production of the tubular bag, handling thereof, or the various phases of its use. This risk of ridge formation thus suggests carrying out a visual inspection of all the joining zones of the necks on the flexible webs to allow removal of spigot/neck units having such ridges from the production chain. In addition, visual inspection is not possible for all plastics. The greatest problem is that failure of the connection during filling may result in major spills with customers, which may in turn result in claims for damages that exceed the costs of the materials.

These inspection operations result in a reduction in the work cycle, whereas rejection of nonconforming connections results in a loss of raw materials and decreased production yields.

Thus, a need has arisen for finding a means that allows elimination of the risk of occurrence of ridges to be able to increase the production yields and reduce the defects originating from the welding process to the greatest extent possible. To achieve this objective, the invention relates to a welding head for fastening an element made of plastic material to a flexible web made of plastic material, of which a flexible container is composed, wherein the head includes a body made of electrically and/or thermally conductive material having a work surface that is provided for being pressed, during the welding operation, against an element of the unit to be joined, characterized in that the work surface includes a series of grooves or concave formations that are essentially uniformly distributed on the surface of the work surface. It has surprisingly and advantageously been found that this texturing of the work surface allows prevention of flow of plastic material out of the melt zone without impairing the quality of the welding that is carried out.

According to one characteristic of the invention, the grooves or the concave formations have a maximum depth that is greater than or equal to the thickness of the web made of plastic material.

According to another characteristic of the invention, the grooves or the concave formations have a maximum depth that corresponds to the material thickness of the fastening collar.

According to yet another characteristic of the invention, the concave formations have a tetrahedral shape.

According to one characteristic of the invention, the body of the welding head is made of metal, preferably copper or a copper-containing alloy, more preferably brass, or a metal having a thermal conductivity of at least 230 W/(m K), in particular aluminum.

According to one embodiment of the invention, the welding head for welding a neck is adapted to the web made of plastic material, and the work surface has an open ring shape in its center.

The invention likewise relates to a welding device that includes means for generating heat in a welding zone, characterized in that the welding device includes a welding head according to the invention that is linked to the heat generating means.

The invention likewise relates to a method for joining, by welding, a flexible web made of plastic material of which a container wall is composed, to a further element made of plastic material, in which the web and the further element are pressed together in the area of a joining zone between a hot work surface of a welding head and a contact surface of a counterhead, with heating of at least the joining zone to a temperature that is sufficient to ensure the weld, the method being characterized in that at least the work surface of the welding head includes a series of grooves or concave formations that are essentially uniformly distributed on the surface of the work surface, so that the flow of molten plastic material out of the joining zone during the welding operation is prevented.

According to one form of use of the method according to the invention, the further element is a neck that includes an annular connecting collar, characterized in that the work surface of the welding head has a ring shape that is essentially identical to that of the connecting collar of the neck.

The invention further relates to a container that is flexible at least in part, and that is formed by joining by welding elements that include at least one flexible web made of plastic material, characterized in that at least one welding zone has an essentially regular pattern that is formed from the alternation of concave and convex and/or light and dark regions.

According to one embodiment, the container includes a neck made of plastic material that is welded to the flexible web via an annular collar, wherein the welding zone of the collar has an essentially regular pattern on the flexible web that is formed from the alternation of concave and convex and/or light and dark regions, and that at the flexible web is free of ridges on the outer side of the welding zone of the collar.

According to one preferred but not exclusive embodiment of the invention, the container represents a flexible tubular bag for storing in particular liquid, semiliquid, or powdered products.

Of course, the various characteristics, variants, embodiments, and forms of use of the invention may be combined with one another in different ways, provided that they are not incompatible or mutually exclusive.

Furthermore, various additional characteristics of the invention arise from the appended description with reference to the drawings, which illustrate a nonrestrictive exemplary embodiment and application examples of the invention.

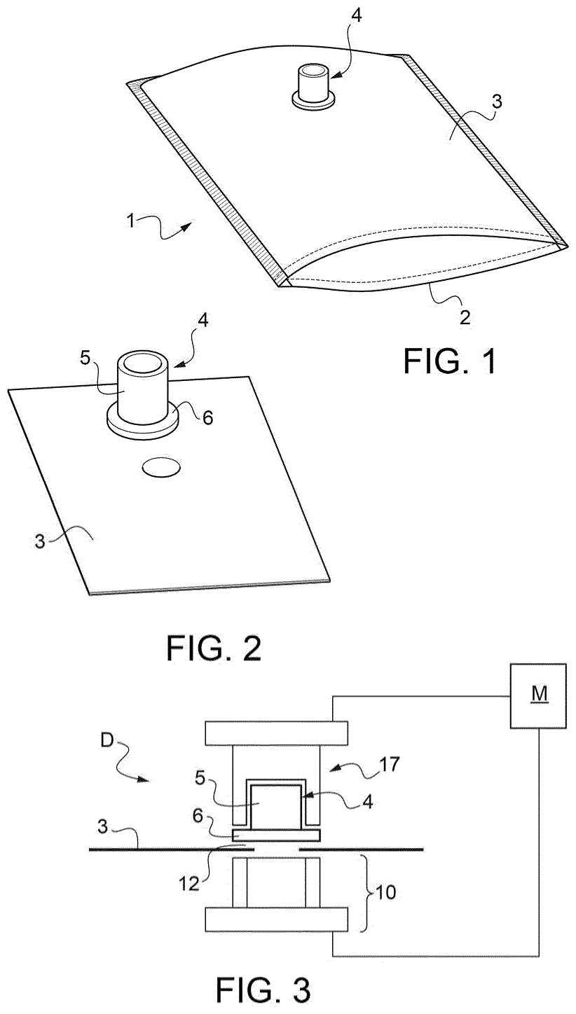

FIG. 1 shows a schematic perspective of a flexible container according to the invention which forms a tubular bag,

FIG. 2 shows a schematic exploded view of a web of which the container illustrated in FIG. 1 is composed, together with a neck,

FIG. 3 shows a schematic view of a device according to the invention for welding a neck made of plastic material to a flexible web made of plastic material,

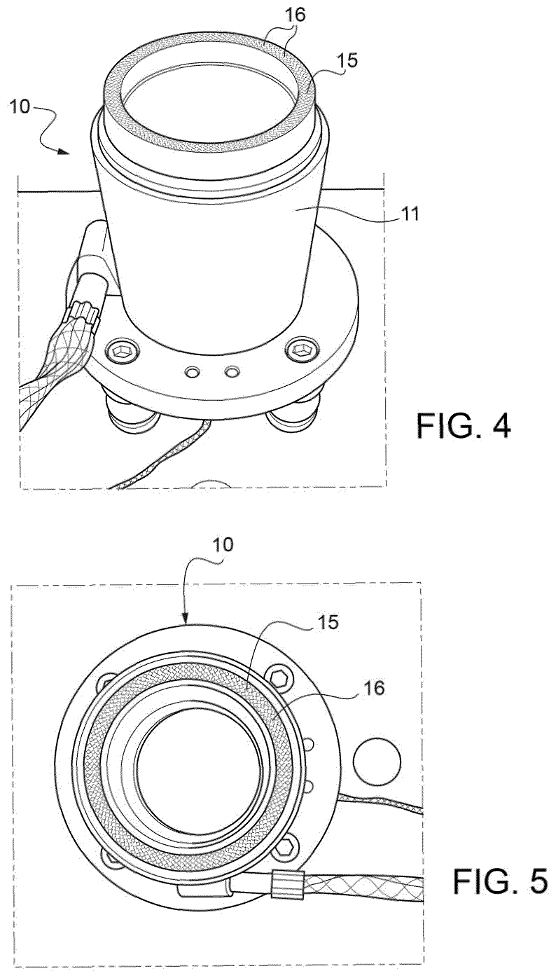

FIG. 4 shows a perspective view of a welding head according to the invention,

FIG. 5 shows a top view of the welding head according to FIG. 4, and

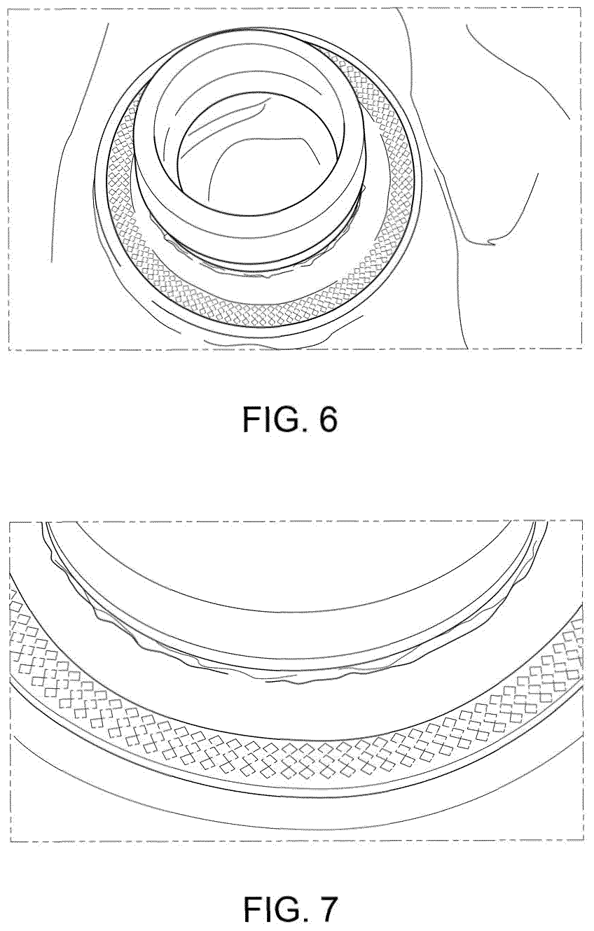

FIGS. 6 and 7 show a sealtight weld produced using the welding head according to the invention, and the light and dark regions in the welding zone.

A flexible tubular bag made of plastic material for storing various products, as illustrated in FIG. 1 and denoted overall by reference numeral 1, is generally formed by joining two flexible webs 2, 3 made of plastic material, which are welded at their circumference. The flexible tubular bag 1 also includes a neck 4 that allows filling of the tubular bag and fitting of a spigot for tapping the contents. According to the illustrated example, the neck 4 is welded sealtight to the upper web 3, of which the tubular bag 1 is composed.

The operation for joining the neck 4 to the web 3 generally takes place before the two webs 2, 3 are joined together. To allow this connection, the neck 4, which has a tubular shaft with a generally cylindrical shape 5, as shown in FIG. 2, includes an annular connecting collar 6 at its base, having a bottom surface that is provided for being welded to the flexible web 3.

A welding device D schematically illustrated in FIG. 3 is used to establish the connection of the neck 4 to the web 3. The welding device includes a head 10 and a counterhead 17 which are adapted so that, in cooperation with one another, they press the collar 6 and the web 3 in the area of a welding zone 12. The head 10 and the counterhead 17 are also connected to means M, for example electrical high-frequency generators or ultrasonic generators, for generating heat in the welding zone. The heat generation means allow activation of the welding zone 12 to bring about melting of at least a surface thickness of the collar 6, thus ensuring a sealtight weld of the neck 5 to the web 3. The devices that are used to ensure either thermal or high-frequency welding or ultrasonic welding are well known to those skilled in the art, and therefore do not require a more detailed description.

As shown in FIGS. 4 and 5, the welding head 10 includes a cylindrical hollow body 11 made of electrically and/or thermally conductive material. In the present case, the body 11 is made of electrically and thermally conductive material, namely, a copper alloy such as brass or bronze.

The body 11 has a ring-shaped work surface 15 that is open in its center, and that includes grooves or concave formations 16 that are essentially uniformly distributed on the surface of the work surface, corresponding to a fundamental characteristic of the invention. These concave formations 16 have essentially the shape of tetrahedrons, for example, that originate from corrugation of the work surface. Of course, the concave formations may have some other design, and, for example, may include an essentially regular grid made up of intersecting furrows.

The concave formations 16 preferably, but not exclusively, have a maximum depth that is greater than or equal to the thickness of the flexible web 3. According to the illustrated example, the concave formations have a maximum depth in the range of 0.5 mm to 1.5 mm.

Once it is adapted to the welding device D, the welding head 10 according to the invention is used as follows, corresponding to the method according to the invention.

The web or webs 3 and the neck 4 are pressed together in the area of the welding zone by means of the head 10 and the counterhead 17, the heat generation means M being activated to generate heat in order to ensure melting of at least the surface thickness of the welding collar at the point of contact with the flexible web 3.

The concave formations of the work surface of the welding head advantageously allow the flow of melting plastic material to be retained in the welding zone, so that neither a ridge nor an overflow of plastic material from the welding zone results.

After cooling, the welding zone, which is discernible on the side of the flexible web, has a series of convex and concave zones and, if the web is transparent or translucent, has alternating light and dark zones.

Furthermore, it has surprisingly and advantageously been found that the use of a welding head having a textured work surface does not impair either the mechanical durability of the weld or the sealtightness thereof, so that the quality of a container that includes a welded neck corresponding to the invention is even further improved, in particular due to the absence of ridges. In addition, the stability of the weld with the welding head is essentially independent of the welding temperature, which allows welding at higher temperatures and in less time, thus increasing the production output.

According to the above-described example, the work surface of the welding head has a ring shape. However, such a formation is not necessary for the design of a welding head according to the invention. Thus, the work surface of the welding head, in particular for carrying out the circumferential welding of a flexible container according to the invention, could in particular be linear.

Of course, various other variants of the invention may be considered within the scope of the appended claims.

1. A welding head for fastening an element made of plastic material to one or more flexible webs made of plastic material, of which a flexible container is composed, wherein the head comprises:
a body made of electrically and/or thermally conductive material having a work surface that is provided for being pressed, during the welding operation, against an element of the unit to be joined, wherein the work surface includes a series of grooves or concave formations that are essentially uniformly distributed on the surface of the work surface.

2. The welding head according to the preceding claim, wherein the grooves or the concave formations have a maximum depth that is greater than or equal to the thickness of the web made of plastic material.

3. The welding head according to claim 1, wherein the grooves or the concave formations have a maximum depth that corresponds to the material thickness of the fastening collar, in particular between 0.5 mm and 1.5 mm.

4. The welding head according to claim 1, wherein the concave formations have a tetrahedral shape.

5. The welding head according to claim 1, wherein the body is made of metal, preferably copper or a copper-containing alloy, more preferably brass.

6. The welding head according to claim 1, wherein the welding head for welding a neck is adapted to the web made of plastic material, and the work surface has an open ring shape in its center.

7. (canceled)

8. A method for joining, by welding, a flexible web made of plastic material of which a container wall is composed, to a further element made of plastic material, in which the web and the further element are pressed together in the area of a joining zone between a hot work surface of a welding head and a contact surface of a counterhead, with heating of at least the joining zone to a temperature that is sufficient to ensure the weld, wherein the method is characterized in that at least the work surface of the welding head includes a series of grooves or concave formations that are essentially uniformly distributed on the surface of the work surface, so that the flow of molten plastic material out of the joining zone during the welding operation is prevented.

9. The joining method according to claim 8, wherein the further element is a neck that includes an annular connecting collar, and the work surface of the welding head has a ring shape that is essentially identical to that of the connecting collar of the neck.

10. A container that is flexible, at least in part, and that is formed by the joining by welding of elements that include at least one flexible web made of plastic material, wherein at least one welding zone has an essentially regular pattern that is formed by the alternation of concave and convex and/or light and dark regions.

11. The container according to claim 10, further including a neck made of plastic material that is welded to the flexible web via an annular collar, wherein the welding zone of the collar has an essentially regular pattern on the flexible web that is formed by the alternation of concave and convex and/or light and dark regions, and that at the flexible web is free of ridges on the outer side of the welding zone of the collar.

12. The container according to claim 11, wherein the container is a flexible tubular bag for storing in particular liquid, semiliquid, or powdered products.

13. The welding head according to claim 1, wherein the welding head is linked to a heat generator in an area of a welding zone that generates heat in the area of the work surface of the welding head.
